(19) United States
(12) Patent Application Publication
(10) Pub. No.: US 2012/0219465 A1
(43) Pub. Date: Aug. 30, 2012

(54) Floating electrode ozone generator

(76) Inventor: Jim Constant, Westmount (CA)

(21) Appl. No.: 13/385,541

(22) Filed: Feb. 24, 2012

(30) Foreign Application Priority Data
Feb. 25, 2011 (CA) 2,732,727

(51) Int. Cl. B01J 19/08

(52) U.S. Cl. 422/186.07

(57) ABSTRACT

An ozone generator which comprises a housing having a hollow tubular member within, the tubular member being slightly spaced from an inner face of the housing to define a treatment space, the treatment space being occupied by a wire mesh which is in continuous contact with both the tubular member and the housing. A gas inlet is provided at a first end of the tubular member and a gas outlet also at the first end, a gas channel extending between the hollow tubular member and the treatment space, and a spark generating member proximate the second end of the tubular member.

### FIELD OF THE INVENTION

The present invention relates to a device for the generation of ozone and more particularly, relates to an ozone generator having a high efficiency and which is easy to manufacture.

### BACKGROUND OF THE INVENTION

Ozone is a naturally occurring compound in the atmosphere. It also may be generated by ozone generators in which the dual atoms of oxygen are subject to electrical discharge to disassociate and to recombine as three atom molecules called ozone (O₃). Ozone is a powerful oxidizing agent and is unstable at high concentrations, decaying into ordinary diatomic oxygen.

Ozone can be generated by several different methods. These include the corona discharge method, ultraviolet light, and cold plasma. The ozone must be generated on site as it cannot be stored and transported like other industrial gases since it quickly decays into diatomic oxygen. Ozone is typically used for disinfection and deodorization. It is used in the food industry for killing insects in stored grain and also killing mold spores from the air in food processing plants. Many hospitals use large ozone generators to decontaminate operating rooms between surgeries.

Its use is also known in aquaculture to facilitate organic breakdown and in agriculture for application on some freshly cut fruits.

### SUMMARY OF THE INVENTION

It is an object of the present invention to provide for an efficient ozone generator which is relatively easily manufactured and also for an arrangement of individual ozone generators which may be utilized to form an apparatus capable of a large capacity ozone generation.

According to one aspect of the present invention, there is provided an ozone generator comprising a housing, a hollow tubular member within the housing, the tubular member being slightly spaced from an inner face of the housing to thereby define a treatment space, a wire mesh mounted between the inner face of the housing and an outer face of the tubular member in the treatment space, the wire mesh being in continuous contact with both the tubular member and the housing, a gas inlet at a first end of the tubular member, a gas channel extending between the hollow tubular member and the treatment space, the gas channel being located proximate a second end of the tubular member, a gas outlet from the treatment space located proximate the first end of the tubular member, and a spark generating member proximate the second end of the tubular member.

The housing is formed in a conventional manner and will include a plurality of fins or flanges extending outwardly therefrom for substantially the entire length of the housing. This allows for an efficient heat dissipation.

The ozone generator utilizes a stainless steel mesh. Using the stainless steel mesh provides for self centering of the electrodes. This eliminates the need for spacers or the like to maintain the gap for the electricity to jump as an arc.

### BRIEF DESCRIPTION OF THE DRAWINGS

Having thus generally described the invention, reference will be made to the accompanying drawings illustrating embodiments thereof, in which:

FIG. 1 is a side elevational view of an ozone generator according to one embodiment of the present invention;

FIG. 2 is a cross sectional view thereof;

FIG. 3 is a perspective view thereof;

FIG. 4 is an end view thereof;

FIG. 5 is a perspective view of the central body portion thereof;

FIG. 6 is a perspective view of the ceramic dielectric;

FIG. 7 is a perspective view of a spacer for the entry into the ozone generator;

FIG. 8 is a cross sectional view of the spacer; and

FIG. 9 is a cross sectional view of the cap utilized with the ozone generator; and

FIG. 10 is a schematic view of a plurality of individual ozone generators coupled together.

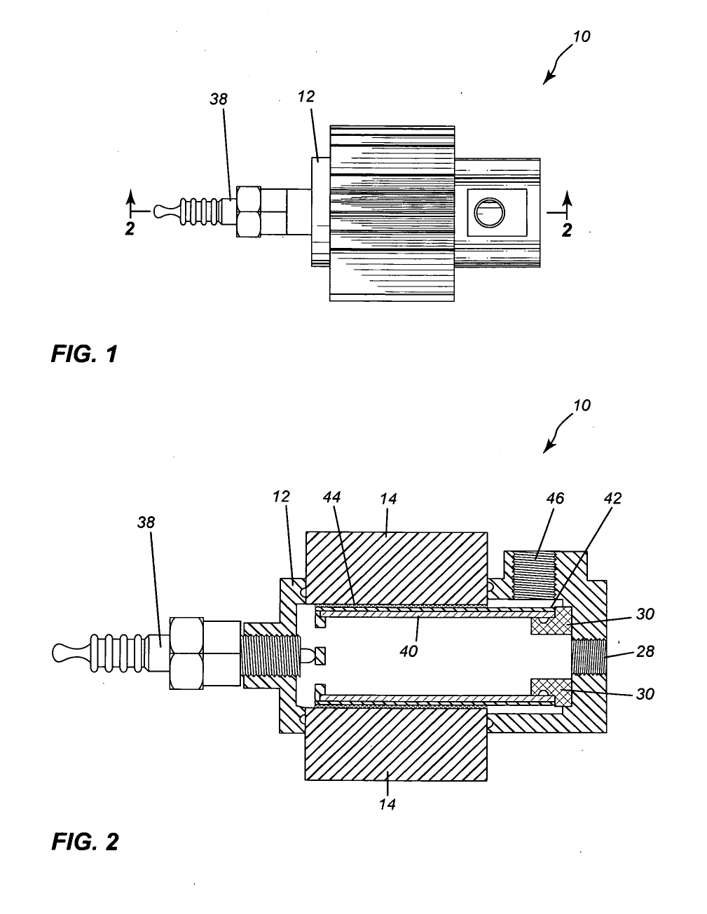

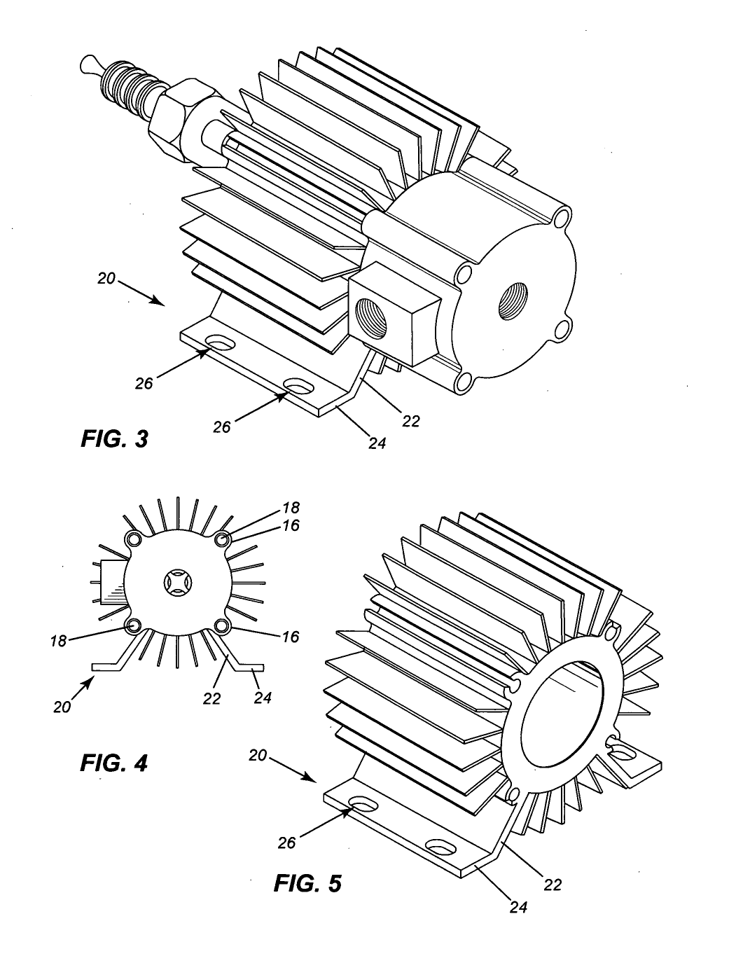

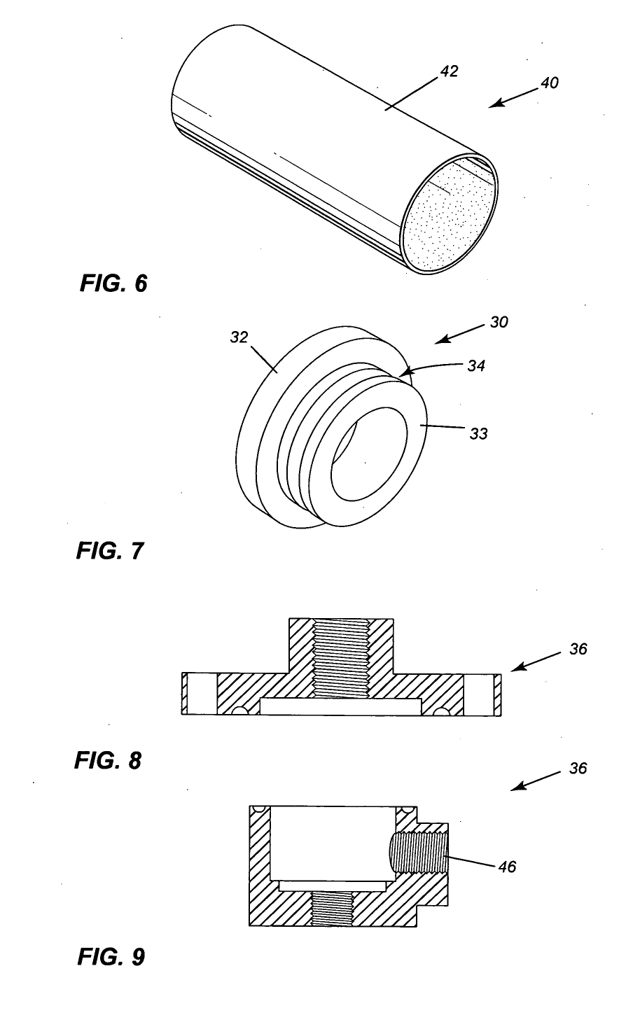

### DETAILED DESCRIPTION OF THE INVENTION

Referring to the drawings in greater detail and by reference characters thereto, there is illustrated an ozone generator which is generally designated by reference numeral 10.

Ozone generator 10 has a housing 12 which, in the illustrated embodiment, is of a cylindrical configuration. Extending outwardly from housing 12 are a plurality of fins or flanges 14. Flanges 14 function to dissipate heat generated within housing 12.

On the outer surface of housing 12, there are provided sets of elements 16 which are of an arcuate configuration and which define therebetween a tubular recess 18. A plurality of such tubular recesses 18 are provided.

A pair of legs 20 extend outwardly from housing 12, each leg having a first leg element 22 adjacent housing 12 and a distal or second leg element 24. The second leg element 24 has a pair of apertures 26 formed therein.

At one end of housing 12, there is provided an air entry aperture 28. A spacer 30 is provided and as may be best seen in FIG. 7, comprises an enlarged portion 32 with a smaller portion 33 having a recess 34 for receiving an O-ring. Spacer 30 is provided for maintaining elements in position as will be seen in greater detail hereinbelow.

At the opposite end to air entry aperture 28, there is provided a cap 36 which has a threaded entry therein to receive spark plug 38.

A tubular element 40 has a ceramic lining 42 and is held in position by spacer 30. A wire mesh 44 is placed between housing 12 and tube 40. A gas outlet 46 is provided adjacent air entry aperture 28. In use, air or ozone enhanced air will be passed through the center portion of housing 12 through air inlet aperture 28. The air will then flow in a reverse direction between ceramic lining 42 and housing 12 where it is subject to static discharge. The gas containing ozone is then collected from gas outlet 46.

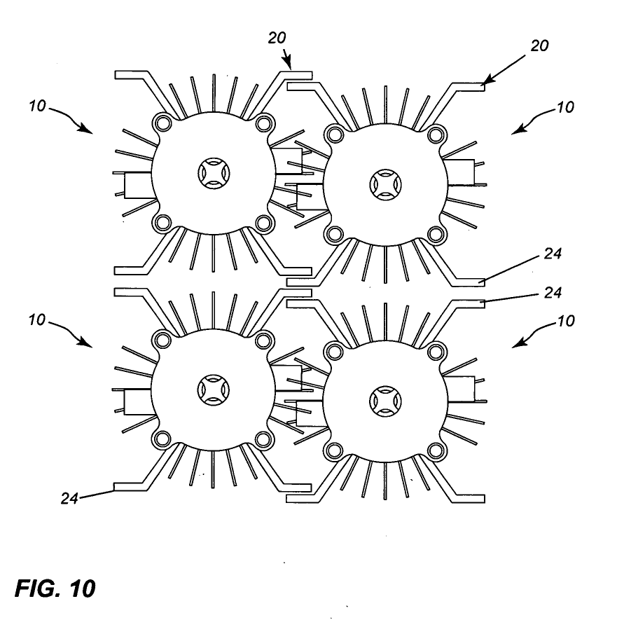

In the embodiment illustrated in FIG. 10, a plurality of ozone generators 10 may be joined together. In this embodiment, each ozone generator 10 has four legs 20 with leg elements 24 being connected together through apertures 26 by suitable means such as nuts and bolts. The generators may be contained within a shell or the like and air input and ozone output may be suitably connected.

Naturally, as is known in the art, suitable electric connections (not shown) are provided.

It will be understood that the above described embodiments are for purposes of illustration only and that changes and modifications may be made thereto without departing from the spirit and scope of the invention.

I claim:

1. An ozone generator comprising:
a housing;
a hollow tubular member within said housing, said tubular member being slightly spaced from an inner face of said housing to thereby define a treatment space;
a wire mesh mounted between said inner face of said housing and an outer face of said tubular member in said treatment space, said wire mesh being in continuous contact with both said tubular member and said housing;
a gas inlet at a first end of said tubular member;
a gas channel extending between said hollow tubular member and said treatment space, said gas channel being located proximate a second end of said tubular member;
a gas outlet from said treatment space located proximate said first end of said tubular member; and
a spark generating member proximate said second end of said tubular member.

2. The ozone generator of claim 1 further including a spacer located at said first end of said tubular member, said spacer retaining said hollow tubular member spaced from said housing.

3. The ozone generator of claim 2 wherein said tubular member has a ceramic lining on an outer surface thereof.

4. The ozone generator of claim 3 wherein said gas outlet from said treatment space is substantially perpendicular to said gas inlet.

5. The ozone generator of claim 1 further including a plurality of fins extending along a length of said housing.

6. The ozone generator of claim 1 wherein said housing has four legs extending outwardly therefrom, each of said legs having an aperture formed at an end thereof to permit coupling to a further ozone generator.

7. The ozone generator of claim 1 further including a cap secured to said second end of said housing, said cap being adapted to retain a spark plug therein.
